(19) United States
(12) Patent Application Publication
(10) Pub. No.: US 2007/0048407 A1
(43) Pub. Date: Mar. 1, 2007

(54) Multicolor image optimization on edible colored products

(76) Inventors: Thomas Collins, Nazareth, PA (US); Arun Shastry, Neshanic Station, NJ (US); Neil Willcocks, Brentwood, TN (US); Jeannette Hainzl, Morristown, NJ (US)

Correspondence Address: FITZPATRICK CELLA HARPER & SCINTO, 30 ROCKEFELLER PLAZA, NEW YORK, NY, 10112, US

(21) Appl. No.: 10/547,536

(22) PCT Filed: Mar. 5, 2004
(86) PCT No.: PCT/US04/07127

§ 371 Date: Aug. 11, 2006

Related U.S. Application Data
(60) Provisional application No. 60/452,896, filed on Mar. 7, 2003.

(51) Int. Cl. A22C 17/10

(52) U.S. Cl. 426/87

(57) ABSTRACT

The present invention is directed to a decorated edible product comprising: a confectionery center, a non-chocolate edible surface, an edible color enhancement coating that is substantially gray colored disposed on at least a portion of the non-chocolate edible surface, and an edible image formed on at least a portion of the color enhancement coating, wherein the color enhancement coating substantially promotes the true colors of the edible image.

### BACKGROUND OF THE INVENTION

1. Field of the Invention

The present invention is directed to decorated edible products and methods of making decorated edible products. More particularly, the present invention is directed to decorated edible products that have an edible image on the product surface.

2. Related Background Art

The placement of pictorial or graphical images on food products is known in the art. The appearance of a graphical image distinguishes the food product from other products by providing it with a decorative feature. Manufacturers have used various means to achieve this desired look. For example, U.S. Pat. Nos. 4,905,589; 5,433,146; and 5,655,453 disclose various means and methods for imprinting confectionery and food products. Furthermore, U.S. Pat. No. 5,800,601 describes ink jet compositions that are suitable for printing messages on edible or ingestible materials.

However, the printed images produced by prior art methods, have often not succeeded in reproducing true vibrant color images on edible products. Often the images are applied onto surfaces that detrimentally affect the printed image's colors. This is largely due to the product's background color, especially when the background color is dark. Moreover, variations in background color can adversely highlight the inconsistency of the colors in the printed image.

Often the creation of images, such as high resolution images, requires the use of non-pigmented water based inks, which are less viscous. However, non-pigmented water based colored inks lack opacity and do not show well on dark colored surfaces or incompatible surfaces. Typically, the color of the underlying surface interferes with the non-pigmented water based ink and creates an unintended and undesirable color blend. For example, when a red colored non-pigmented water based ink is applied to a green colored surface, the resulting color is an undesirable bronze color. This occurs even with more viscous pigmented rotogravure type inks, where the red color appears bronze colored. This poses a problem since none of the available edible colorants or inks has been found to have the capacity to produce true color images on more challenging colored backgrounds. Additionally, the available edible water-based colorants and inks tend not to work on hydrophobic surfaces, such as the wax-polished sugar shell surfaces of M&M's® Milk Chocolate Candies.

This issue has only been partially addressed by U.S. patent application Ser. No. 09/738,671 (hereafter the '671 application), which discloses a confectionery product containing a high resolution edible image printed on a chocolate substrate. This is achieved by applying a substantially white image substrate coating on the chocolate substrate, which negates the effect that the chocolate substrate has on the colored edible inks that are subsequently applied to produce the high resolution edible image. The '671 application also discloses that the substantially white image substrate coating may be useful when printing images on non-chocolate confectionery, such as a lollipop, that has a sugar based layer with a dark colored surface. Dark colored surfaces are considered to be those surfaces that do not provide a good contrasting background for a colored or black image. However, the '671 application does not fully appreciate the need to print edible images on products that have a non-chocolate edible surface.

When the background surface is colored, the surface color modifies the image color and a true color is difficult to obtain. This is true whether the surface is a chocolate substrate or a non-chocolate edible surface. The '671 application only addresses the situation when the surface is a chocolate substrate. The present invention expands and resolves this issue, by providing a method of producing a higher quality printed image on a non-chocolate edible surface, where the printed image can be consistently displayed in bright, vibrant true colors. In particular, the present invention addresses the issue of printing on hydrophobic non-chocolate edible surfaces.

### SUMMARY OF THE INVENTION

The present invention is directed to a decorated edible product comprising: a non-chocolate edible surface, an edible color enhancement coating disposed on at least a portion of the non-chocolate edible surface, and an edible image formed on at least a portion of the color enhancement coating. Enhanced colors of the edible image are achieved by the application of the color enhancement coating. Preferably, the non-chocolate edible surface is a carbohydrate based material, a hydrophobic material, or a proteinaceous material.

The present invention also includes a method for making a decorated edible product having an edible image applied to a surface thereof, comprising the steps of: (a) providing an edible product having a non-chocolate edible surface; (b) applying a color enhancement coating to at least a portion of the non-chocolate edible surface; and (c) applying an edible image onto at least a portion of the color enhancement coating, wherein the color enhancement coating substantially promotes the true colors of the edible image.

In another embodiment, the invention provides a decorated edible product comprising: a light colored non-chocolate edible surface, an edible color enhancement coating disposed on at least a portion of the light colored non-chocolate edible surface, and an edible image formed on at least a portion of the color enhancement coating, wherein the color enhancement coating substantially promotes the true colors of the edible image.

### DETAILED DESCRIPTION OF THE INVENTION

For the purposes of the present invention, the term “chocolate” refers to milk chocolate, dark chocolate, white chocolate, or any non-standard of identity (SOI) chocolate that mimics the appearance and flavor of SOI milk chocolate or dark chocolate. Accordingly, the term non-chocolate excludes chocolate. It should be apparent, however, that while the surface of the decorated edible of this invention are non-chocolate, this does not preclude the confectionery from containing chocolate, such as a chocolate center.

For the purposes of the present invention, the phrase “true color” is used to describe a color that has the proper intensity and tone when applied. Color is defined in terms of hue, value and chroma. Hue represents the color family. For example, the surface may have a hue of orange, blue, red, etc. Value represents the lightness or darkness of the color. The brighter a color is, the higher is its value and the more light it emits. Chroma is the strength or intensity of the color. It is an indication as to how different a pure hue is from a gray shade. Colors with strong chroma are considered bright and saturated. Colors with low chroma are considered dull.

Tint and Shade describe the variation of a given color by the change in its value. For example, if white paint is added to a dark red paint, the lighter version of the red color is now called a tint of the original red. Similarly, when black is added to a color, the new color is called the shaded version of the original color.

For the purposes of the present invention, the term “enhanced color” is meant to describe a color that is perceived to be a truer color when viewed by an observer. The truer color has a hue, value and/or chroma that directionally moves closer to the true color, e.g., Munsell Color System value.

In addition, for the purposes of the present invention, the term “image” refers to any picture or pictorial image, pattern, symbol, text or alphanumeric character or group of characters.

When a color is observed against a colored background, the color may be adversely affected by the contrasts in hue, value, and chroma. For example, a light colored background with a dark colored image, will make the dark colored image appear even more darker. While a dark colored background with a light colored image, will make the light colored image seem more lighter.

The present invention is directed to a decorated edible product that includes a non-chocolate edible surface, an edible color enhancement coating disposed on at least a portion of the non-chocolate edible surface, and an edible image formed on at least a portion of the color enhancement coating. The invention has particular applicability to printing with a piezo jet printhead on a hydrophobic based surface, such as a waxed polished surface. In a preferred embodiment, the ink jetted image applied to the color enhancement coating is comprised of one or more water based colored inks. In another preferred embodiment, the ink jetted image applied to the color enhancement coating is comprised of one or more edible wax or fat based colored inks, such as those described in co-pending co-pending patent application (Attorney Docket No. 02280.003530) titled, “Edible Inks For Ink-Jet Printing On Edible Substrates,” filed contemporaneously.

The edible color enhancement coating may be any opaque color, which does not detrimentally alter the original color of the edible ink that is used to form the edible image. Preferably the color enhancement coating is a neutral opaque color. More preferably, it is a white or gray scaled color, i.e. any gray color ranging from black to white. Significantly, the selection of the color of the color enhancement coating may be varied depending on the color of the edible surface and the color of the image that is applied to the color enhancement coating. It should be understood that it is not necessary that the inks used to form the edible image, e.g., high resolution image, be non-pigmented. However, for providing opacity to the background, pigmented inks perform better than non-pigmented inks.

By including and applying a color enhancement coating, prior to printing the edible image, the color of the non-chocolate edible surface is substantially negated. So, when the image is printed, the true colors of the inks and the image can be brought out and substantially reproduced on the coating.

A useful method of evaluating colors is the Munsell Color System, which is well known to one of ordinary skill in the art. This method is widely used by artists, designers, and others who require a less ambiguous way of describing colors. Munsell identifies colors based upon three attributes, hue, value, and chroma. Each color is then given an alpha numerical value. Additional information about the Munsell Color System may be found in U.S. Provisional Patent Application Ser. No. 60/452,896 filed Mar. 7, 2003, the disclosure of which is incorporated by reference herein.

Hue identifies the family of the color. The major family of hues includes red, yellow, green, blue, and purple. The minor family of hues are orange (yellow-red), green-yellow, blue-green, purple-blue, and red-purple. In the Munsell System, there are ten hue families presented in a color wheel. The ten hue families are each further divided into ten subfamilies. The true hue for a family is at the center and assigned the number 5. The number 10 is assigned to the hue that is halfway between two adjacent true hue families.

Value characterizes the lightness or darkness of a color. Sometimes the value is thought of in terms of tints or shades. Tints are thought of as light colors, for example, colors to which white color has been added. While shades are thought of as dark colors. Neutral colors have no hue and are designated by an N and an integer and a slash. For example, absolute black is noted as N 0/. Thus changes in value from black to white can be characterized using the Munsell system.

Chroma is the strength or intensity of a color. It can be used to distinguish a strong color from a weak color. Strong, vivid, or highly saturated colors have a high chroma. While colors that are considered weak or dull have a low chroma. Another way of understanding chroma is that it is the difference from a pure hue to a gray shade.

The color of the color enhancement coating is selected by evaluating the background color or the color of the non-chocolate edible surface, and the image color. Table 1 provides guidelines for selecting a gray scaled color for the color enhancement coating under varying circumstances.

TABLE 1

| Edible Image | Non-Chocolate Edible | Color Enhancement |
|---|---|---|
| Color | Surface Color | Coating |
| Light | Dark | White to Light Gray |
| Dark | Light | Dark Gray to Black |
| Medium | Light | Light to Medium Gray |
| Dark | Dark | White to Light Gray |
| Light | Light | White to Light Gray |

Although Table 1 provides guidelines for the use of a gray scaled color enhancement coating, it should be understood that the color enhancement coating may be any color so long as the coating results in an enhanced colored image. Preferably, a true color image.

The decorated edible product has a non-chocolate edible surface, which may be, for example, a carbohydrate based material, a hydrophobic based material, a proteinaceous based material, or a pharmaceutical based material. Carbohydrate based materials include, but are not limited to, sugar compounds, glazes, dextrin, maltodextrins, shellac, gum arabic, gelatin, and the like. Hydrophobic based materials are generally exemplified by wax and/or oily surfaces. Non-limiting examples include polishes such as carnauba wax, candelilla wax, beeswax, fats, and the like. Proteinaceous based materials are, for example, food proteins and protein extracts such as whey protein, milk caseins, albumins, plant proteins such as soy proteins, peptide fragments of animal and plant source such as hydrolyzed proteins, and can also include simple amino acids and the like. Suitable pharmaceutical based materials include, for example, pharmaceutical grade ingredients, colorants, binders, film formers, and the like. Examples of film formers include celluloses and modified celluloses, such as hydroxyl propyl methyl cellulose (HPMC). In a preferred embodiment, the non-chocolate edible surface is a hydrophobic based material. It should be recognized, however, that the non-chocolate edible surface may, if desired, fully cover or partially cover a chocolate component of the edible product, e.g., a confectionery.

It may be preferable to prepare the non-chocolate edible surface prior to application of the edible color enhancement coating by applying a coating that enhances the adherence of the substrate coating to the non-chocolate edible surface. This is particularly usefull when the non-chocolate edible surface is primarily a hydrophobic based material. For example, water-based glazes containing gums and/or corn syrups and/or oils, and/or acids and/or sugars and/or starches and/or low-carbon alcohols and/or shellacs and other resins may improve the adherence of the coating to the non-chocolate edible surface. Solvent based glazes may also be useful. Commercial names of exemplary water-based glazes include, without limitation, commercially available Capol 140, Capol 120, Capol 153D, Capol 149 products, available from Centerchem Foods, Stamford, Conn.

Depending on the composition of the non-chocolate edible surface, the surface may be modified with surfactants, such as ADMUL-PGE1425K available from Uniqema, Brantford, Ontario, Canada

Another embodiment of the invention involves the application of more than one surface pre-treatment layer prior to applying the edible color enhancement coating. For example, the non-chocolate edible surface can be treated with a first pre-treatment application of a surfactant, such as ADMUL-PGE1425K, followed by a second application of Capol. Preferably, the ADMUL-PGE1425K is applied by spraying followed by brushing with a soft plastic brush to provide a smooth highly compatible surface for application of the next coating, e.g., a corn syrup water-based glaze or application of the edible color enhancement coating. Other examples include shellac coated ingredients.

It should be understood that the edible product by itself, may or may not contain chocolate, so long as the surface upon which the edible color enhancement coating is applied is a non-chocolate edible surface. For example, in a confectionery product, the center of the product may be of any confectionery type, such as chocolate, nuts, sugar, peanut butter, peanut creams, fondants, creams, nougat, brittles, caramels, and the like.

The edible color enhancement coating may cover the entire surface of the non-chocolate edible surface or only a portion of the surface. Typically it will substantially cover at least that area on the non-chocolate edible surface that will be defined by the printed edible image. In so doing, the color enhancement coating provides sufficient opacity to block out the color of the underlying non-chocolate edible surface or other underlying visible layer. This makes it possible to apply the edible image onto a surface in a manner that will bring out the true vibrant colors of the printed edible image.

In one embodiment, the color enhancement coating is comprised of at least one of a binding agent, a food grade white ink that typically will be pigmented, a sugar or mixtures thereof. Preferably, the binding agent is one or more starches. Exemplary binding agents include starches, cellulose, gum arabic, dextrin and the like. Exemplary starches include corn starch, rice starch, wheat starch and the like. Exemplary sugars include sucrose, dextrose, fructose and the like. A preferred food grade white pigment is titanium dioxide. An alternative to titanium dioxide is calcium carbonate. A preferred black food grade pigment is carbon. Alumina may also be used as a pigment. Most preferably, the edible color enhancement coatings are mixtures of starch and titanium dioxide and mixtures of starch and carbon. Preferred mixtures of binding agent and titanium dioxide generally have a weight ratio of titanium dioxide to binding agent in a range of from about 5.5:0.1 to about 0.9:1, preferably about 2.2:0.5 to about 0.9:1, more preferably about 2.2:1 to about 0.9:1, even more preferably about 1.7:1 to about 1:1, and most preferably about 1.4:1 to about 1.1:1. Preferred mixtures of binding agent and carbon generally have a weight ratio of carbon to binding agent in a range of from about 10.0:0.1 to about 0.9:1, preferably about 5.5:0.5 to about 0.9:1, more preferably about 2.2:1 to about 0.9:1, even more preferably about 1.7:1 to about 1:1, and most preferably about 1.4:1 to about 1.1:1.

It has also been found that the inclusion of corn syrup in the color enhancement coating results in a glossy substrate coating and that the surface characteristics of the coating can be altered by adjusting the amount of corn syrup added to the coating solution. Corn syrup may be added directly or may be incorporated by the addition of corn syrup containing glazes. An exemplary corn syrup containing glaze that may be used in the coating solution includes water based glazes such as the commercially available Capol 140, Capol 120, Capol 153D, Capol 149 products available from Centerchem Foods, Stamford, Conn.

As previously discussed, the invention utilizes an edible color enhancement coating to provide a contrasting background that allows for the formation of highly defined white, black or true colored images on the non-chocolate edible surface of the edible product. To achieve this contrasting background, the substrate coating is generally formulated to provide sufficient opacity to block out the visible color beneath Typically, the opacity should be 40%-100%, that is, the perceived color of the background is reduced by that percentage. This is typically assessed using the Munsell System charts as a reference. Preferably, the coating is a substantially gray scaled color. The variety of gray tone or gray scale color enhancement coating backgrounds that may be used is dependent upon the image to be printed and the color of the product to be printed. The gray tone for the coating should be selected to minimize the foreground and background color interferences. If the foreground is a lighter color, e.g., yellow, and the background is also a light color, e.g., orange, then the gray scale coating needs to be adjusted such that the shade is significantly dark. However, if the foreground is a maroon color, and the background is a dark blue, then a paler border gray shade, e.g., light gray or even white, needs to be selected. As used herein “substantially gray” includes color tones ranging from white to black.

A preservative may also be included in the edible color enhancement coating solution. Exemplary preservatives include potassium sorbate and citric acid. Preferably, if water by itself is used as an evaporable solvent, then a preservative is included. Other optional ingredients that may be included in the edible color enhancement coating solution include maltodextrin, isomalt and corn syrup solids. It may also be preferable to include an antifoaming agent, particularly when the color enhancement coating solution is applied by spraying.

The edible color enhancement coating solution may be applied by techniques such as ink jet printing, spraying, roller coating, pad coating, air brushing, etching, laser printing, offset rotogravure, flexographic, gravure printing processes or the like, so long as the non-chocolate edible surface is covered in the desired manner. For example, either precise spraying can be used or a mask may be employed on the non-chocolate edible surface. If desirable, the edible color enhancement coating may be used to form a border around an edge or the perimeter surrounding the image.

The edible color enhancement coating may be preferably applied by inkjet printing. In this manner, the gray tone applied to the non-chocolate edible surface may be readily varied or evenly applied. Application of the edible color enhancement coating may be performed by either a single application of the solution or multiple applications of the solution.

All types of edible inks may be used. The edible ink may be, for example, wax based inks, water based inks, white inks, black inks, colored inks, pigmented inks, non-pigmented inks, solvent based inks, phase changing inks, and the like. Water based inks are preferred. However, it should be understood that the selection of the ink is somewhat dependent upon the method of printing that will be employed. For example, inkjet printers may use inks that are from about 5 cps to about 100 cps. While pad printers generally use inks that are from about 200 cps to about 800 cps.

The edible color enhancement coating is prepared from a coating solution comprised of (a) an edible color enhancement coating setting system and (b) an edible colorant system. The edible color enhancement coating setting system has (i) an evaporable system that is either a water or a water/alcohol system, and (ii) a binder or a wax based solidifiable system. The edible colorant system can include dyes, inks, lakes, pigments, and/or opacifiers.

In one aspect, the invention is a non-conductive, non-pigmented ink-jettable edible ink for printing on an edible substrate comprising a colorant, a carrier for the colorant, and a vignetted system. The vignetted system contains either: an alcohol, polyol or a mixture thereof; or a fat. The vignetted system is selected such that ink has a viscosity in a range of about 5 centipoise to about 20 centipoise and a surface tension of less than about 50 dynes per centimeter at the conditions under which the ink is applied to the edible substrate.

In the case where the vignetted system contains a fat, the carrier is fat-dispersible, such as without limitation, glycerol or propylene glycol. The inks with a fat in the vignetted system are referred to herein as “fat-based inks.” A fat dispersible carrier such as propylene glycol in a fat-based ink according to the invention is able to solubilize a water-based FD&C approved dye and can be dispersed with the dispersed colorant in a fat base such as carnauba wax serving as the vignetted system.

The inks with a water carrier are referred to herein as “water-based inks.” In the case where the carrier is water, the vignetted system contains at least an alcohol, polyol or a mixture thereof in the vignetted system. Thus a water based ink according to the invention may include a fully solvated FD&C dye in water, and an vignetted system containing at least an alcohol, polyol or a mixture thereof added to reduce the surface tension of the ink below about 50 dynes/cm and to reduce the drying time. The vignetted system preferably further contains an adhesive agent selected from saccharides (such as simple sugars), or polysaccharides, (such as starches, dextrins or gums), depending on the edible substrate. The vignetted system may further include a polymeric binder, including without limitation, shellac, polyvinylpyrrolidone and mixtures thereof.

In the water-based inks, the function of the coating setting system is primarily to increase adhesion of the ink for the surface, to provide for a reasonable drying time, and to ensure the proper physical characteristics of the ink.

As the surface tension of water is high (about 72 dynes per centimeter), it is preferable to add a component to the coating setting system of the water-based inks to lower the surface tension to below about 50 dynes/cm and preferably to a range of about 25 to about 45 dynes/cm to permit efficient printing on an edible substrate with a piezojet printhead. An alcohol, polyol or mixture thereof is provided for this purpose. Preferred are C1-C6 alcohols, propylene glycol and mixtures thereof. Ethyl alcohol, isopropyl alcohol, n-butyl alcohol and propylene glycol are all effective to reduce surface tension and suitable for use in the coating setting system.

Another function of the coating setting system is to reduce the drying time of the ink. The colorant needs to release the fluid matter from the area of image delivery to prevent the image from smearing on contact. Ethyl alcohol, butyl alcohol and isopropyl alcohol are also effective to reduce drying time.

Both the fat based inks and the water based inks according to the invention may be adapted for ink-jet printing on edible surfaces. They may be compatible with existing industrial piezojet technology and the vignetted system is selected so that they are compatible with the surfaces of edible substrates.

The edible enhancement coating is preferably prepared using water-based and solvent-based inks that can be ejected through a continuous jet or drop-on-demand ink-jet printhead. Solvent-based inks include fat-, wax-, and oil-based inks.

A preferred edible colorant for use with the invention is an FD&C dye. The FD&C dyes include Red No. 3 (Erythrosine), Red No. 40 (Allura Red), Yellow No. 6 (Sunset Yel. FCF), Yellow No. 5 (Tartrazine), Green No. 3 (Fast Green FCF), Blue No. 1 (Brilliant Blue FCF), Blue No. 2 (Indigotine). Mixtures of these dyes may also be used.

Natural colorants, such as annatto seed extract, anthocyanins, which are found in various berries, grapes, cabbage, and cranberries, carotenoids, which are found in carrots, and oleoresins from roots, such as tumeric, paprika, carmines, beet roots, and tomatoes, are also usefull in the invention. As some natural colorants are fat soluble, and some are water soluble, the natural colorants find utility in both water and fat-based inks.

It is also possible to use pigments and lakes. Pigments comprise fine, usually inorganic particles used to impart color when dispersed in a base. Examples of pigments include, without limitation, kaolin, chalk, titanium dioxide, and aluminum hydroxide. A lake comprises fine particles, such as aluminum hydroxide particles bound to a colorant, such as one of the FD&C or natural colorants mentioned above. Examples include, without limitation, FD&C Blue #1 Lake, FD&C Blue #2 Lake, FD&C Yellow #5 Lake, FD&C Yellow #6 Lake, Erythrosine Lake, Amaranth Lake, Ponceau 4R Lake, Carmoisine Lake and FD&C Red 40 Lake, all of which may be obtained from the Warner Jenkinson Company, St. Louis, Mo.

Preferred water-based non-pigmented inks include water in an amount between about 30 and about 95 percent by weight, preferably between about 30 and about 85 percent by weight, and a soluble colorant in an amount between about 100 ppm and about 5 percent by weight, preferably between about 100 ppm and about 2 percent by weight. Water-based, non-pigmented inks suitable for use in connection with the present invention are available under product numbers CI 15050-D, CI 10572-D, and CI 12022-D, available from Colorcon, Inc., West Point, Pa. Another series of ink-jet printing inks is commercially available from PhotoFrost Decorating Systems, Blytheville, Ariz.

It is also highly desirable to be able to print on the surface of confectioneries using pigmented inks that provide at least some color opacity. Preferred water-based pigmented inks include water, which is preferably deionized, in an amount of about 30 to about 85 percent by weight, preferably about 30 to about 75 percent by weight, and pigment particulates in an amount of about 3 to about 45 percent by weight, preferably from about 3 to about 35 percent by weight. The dispersion of the pigments in such inks generally must be maintained, as known in the art. Usually, a dispersant, such as glycerine or other polyol, e.g., polyethylene glycol, is used in an amount between 1 percent by weight and 50 percent by weight. Water-based pigmented inks may also contain one or more non-aqueous solvents in an amount less than that of the water in the ink. Preferably, the non-aqueous solvents are present in an amount of less than about 40 percent by weight. Preferred water-based pigmented inks may optionally contain one or more dyes in an amount of 100 ppm to about 2 percent by weight.

An exemplary water-based white pigmented ink suitable for use in connection with the present invention comprises from about 10 to about 45 percent by weight titanium dioxide, from about 1 to about 48 percent by weight dispersant, preferably glycerin, up to about 40 percent by weight lower molecular weight alcohol, preferably ethanol, from about 30 to about 75 percent by weight water, and less than about 1 weight percent surfactant. Other water-based pigmented inks, such as those described in U.S. patent application Ser. No. 09/587,108, may be used as well.

Edible, solvent-based colorants useful with the invention include pigmented and non-pigmented, solvent-based colorants, which, as noted above, may be fat-, wax-, or oil-based colorants. Other solvent-based, pigmented colorants include a non-aqueous solvent present in an amount of from about 15 to about 80 percent by weight, and pigment particulates present in an amount between from about 5 and about 50 percent by weight.

Fat- and oil-based colorants useful in the invention contain a food grade colorant, a dispersant to carry and/or dissolve the food colorant, and a fat or oil base, where an oil is defined as a fat that is liquid at room temperature. “Fat” as used herein includes both fats and oils, either of which may be saturated or unsaturated, and may include substituted and unsubstituted hydrocarbon chains. Fat also includes “fat-like” substances such as limonenes and terpenes, and also includes lipids. Suitable fats that can be used to make the colorants of the invention are hydrogenated vegetable fats, milk fat, cocoa butter, edible fractions of mono-, di- and triglycerides and their derivatives, fats commercially available under the brand name Captex® 300 brand triglyceride, and vegetable oils.

In preferred embodiments, the food grade colorant is an FD&C dye dissolved in a fat-dispersible carrier. The dye and carrier together form a dispersed phase that is distributed in a fat-based continuous phase. In other embodiments, the colorant is a pigment or lake having a fine particle size. In this case, the carrier need only disperse the colorant and mix well in the fat phase. The carrier does not need to dissolve the colorant. Finely divided pigments may also be added to improve the opacity of the colorant.

Where an FD&C dye is used with a fat-based colorant, it is necessary to dissolve the food colorant in a carrier, which is then dispersed into the fat phase. Preferably, colorant is added to the carrier in an amount close to the solubility limit of the carrier for the solvent. The preferred carrier system for FD&C dyes is based on one or more polyols, such as propylene glycol or glycerol. It is also contemplated that the colorants can also be dispersed into water or other polar solvents prior to dispersing into the fat phase. The important characteristics of the carrier system are that it can dissolve the colorant, and is dispersible within the fat phase. Preferably, the FD&C colorant is soluble in the carrier in an amount at least about 1 gram per 100 ml, more preferably, in an amount greater than about 5 grams per 100 ml, and, most preferably, in an amount greater than about 18 grams per 100 ml, where the upper limit to the ink concentration is the solubility limit of the ink in the carrier. Polyols have a good balance of fat-compatibility and solubility for most colorants.

To prepare the fat-based colorant solution, the colorant is simply added to the carrier and mixed. However, it may be necessary to filter the carrier/colorant mixture. If a colorant is added near the solubility limit of the carrier, a 2.7 micron filter may be used to remove larger particles. In the case of a pigment-based system, a 10 micron filter may be used to remove the largest particle size pigments.

Similarly, wax-based colorant solutions may be used with the invention. “Wax” generally refers to edible waxes such as carnauba wax, bees wax, and candelilla wax, which are solid at room temperature. A combination of waxes may also be used. Wax-based colorants useful in the invention contain a food grade colorant and a wax base, and require a dispersant to carry and/or dissolve the food colorant in the wax base. In preferred embodiments, the food grade colorant is an FD&C dye dissolved in a wax-dispersible carrier. The dye and carrier together form a dispersed phase that is distributed in a wax-based continuous phase. In other embodiments, the colorant may comprise a pigment or lake having a fine particle size. In this case, the carrier need only disperse the colorant and mix well in the wax phase. The carrier does not need to dissolve the colorant. Finely divided pigments may also be added to improve the opacity of the colorant.

The preferred wax-based material undergoes a phase change from a liquid state to a solid state upon contacting the substrate surface. By undergoing a phase change, the wax provides certain properties to the inks such as opacity, good adhesion to the substrate, and good surface chemistry for printing onto hydrophobic substrate surfaces, and the ability to print onto non-porous surfaces.

The surfactants that may be used in the ink of this invention include, for example, anionic surfactants, cationic surfactants and amphoteric surfactants. Of course, the surfactant used must also be edible in the amounts used. Polyglycerol oleates, monostearates, polysorbates, mono- and diglycerides, and phospholipids, including without limitation lecithin, may be used for this purpose. Generally, a surfactant will be present in amounts less than about 1.0 weight percent. Most preferably, the surfactant will be present in an amount between about 0.001 and about 0.5 weight percent, based on final ink-formulation.

All of the above-described inks may also include conventional additives such as flavorings, preservatives, antifoam agents, micronutrients, dispersion stabilizers, anti-bloom agents, anti-oxidants, film formers and binders, proteinaceous materials, and the like, as practiced in the art.

Inkjet printing systems are broadly divided into continuous jet, and drop-on-demand (also called “impulse”) systems in which droplets are generated as needed for ejection to the substrate surface for image formation. Methods of ink-jet printing on edible substrates using continuous jet technology are known. Most of these are directed to labeling and the like applications which do not require high resolution. Ink jet printing involves the production of tiny droplets of ink that are fired by a jet mechanism to a substrate to form an edible inkjet printed image. A typical inkjet printer has 4 ink jet print engines individually containing 3 complementary colors and black to allow the production of a broad range of colors. However, color printers having as few as 3 ink colors or as many as 12 colors are available and a white ink could be substituted for black. Inkjet printing on edible products is disclosed in co-pending application Ser. Nos. 10/211,592 filed Aug. 5, 2002 and 09/587,108, filed Jun. 2, 2000. The preferred method of applying the color enhancement coating is by ink jet printing. Using inkjet printing enables the color enhancement coating to be applied in a controlled manner so that the coating is applied accurately, the thickness of the coating can be varied, and one or more different shades of gray color may be applied. Preferably, the edible color image enhancement coating is applied by piezo jet printing using one or more piezo jet print engines. In a particularly preferred embodiment, two print engines are used in which one is used to apply droplets of an edible white image enhancement coating and the second one, droplets of an edible black image enhancement coating. In this manner it is possible to produce finely detailed and specific gray scale edible image enhancement coatings. In an even more preferred embodiment, the black and white print engines are combined with additional engines containing colored image enhancement coatings, permitting the application of more complex enhancement coatings where white and/or black coating is intimately mixed with colored coatings. In a most preferred embodiment, a colored image enhancement coating is applied in a complex pattern containing different colored regions wherein the different colored regions are applied to correspond with different colored regions of a complex image to be printed over the colored image enhancement coating, such that each different colored region of the complex colored image is printed directly over an optimally colored region of the colored image enhancement coating resulting in enhanced color perception of at least one or more of the colors in the complex colored image.

In continuous jet systems, ink is emitted in a continuous stream under pressure through at least one nozzle. The stream is broken up into droplets at a fixed distance from the orifice, typically, by a piezoelectric crystal, which is vibrated at controlled frequency adjacent to the ink stream. To control the flow of ink droplets, these inks are charged (by addition of salts and other conductive agents) and the droplets are passed through an electrostatic field, which adjusts the trajectory of the droplets, in accordance with digital data signals. The droplets are either directed back to a gutter for recirculation or to a specific location on the substrate to create the desired character matrix. A typical resolution for a continuous jet printer image in an industrial setting, using a single printhead and a single pass printing is about 70-90 dpi.

Drop-on-demand systems, such as piezo jet and bubblejet (sometimes referred to as thermal inkjet) systems. In bubblejet systems, a bubble is formed by a resistance heater in an ink reservoir. The resulting pressure wave from the bubble forces ink through the orifice plate. Once the heat is removed, the bubble collapses and a droplet is ejected. Bubblejet printheads dominate the home and office ink-jet printer markets and they are capable of very high resolution. However, thermal inkjet systems tend to not work well with pigmented systems and systems containing binders. Such systems tend to cause frequent blockages of the channels in the print engine.

A method of ink-jet printing on edibles is described in co-pending U.S. patent application Ser. No. 09/587,108, incorporated herein by reference. The ink described therein is a pigmented white ink which has found utility in ink jet printing on chocolate.

It is also desirable to apply the edible color enhancement coating in a manner that produces a substrate that is as thin as possible while providing the necessary contrasting background for printing with for example, white, black or colored edible inks. If the substrate is too thick, the substrate will look laminated and more importantly, will be subject to greater damage from abrasion (e.g., chipping or flaking off of the substrate). Generally the color enhancement coating will have a thickness in a range of about 1.8 mm to about 0.05 mm, preferably about 1.5 mm to about 0.05 mm, more preferably about 1.2 mm to about 0.05 mm, and most preferably about 1 mm to about 0.05 mm.

If necessary, a drying period may be provided to allow the edible color enhancement coating to bond to the non-chocolate edible surface after application of the edible color enhancement coating. The drying may take place under ambient conditions or be aided by passing warm dry air over the non-chocolate edible surface. The temperature of the air should be maintained below a temperature that would be detrimental to the non-chocolate edible surface and/or the product as a whole. For example, a product with a non-chocolate surface surrounding a chocolate center would be subject to sever damage if the chocolate center were melted from high temperatures used in drying the edible color enhancement coating. However, a drying period is not a requirement. In some instances, the edible color enhancement coating may be applied and immediately followed by applying the edible image, e.g., a high resolution ink jet printed image.

The edible image may be applied using any suitable technique. Methods, include for example, inkjet printing, spraying, roller coating, pad coating, air brushing, etching, laser printing, offset rotogravure, flexographic, gravure printing processes, and the like. Preferably, the edible image is a high resolution ink jet printed image that is deposited using drop on demand ink jet printing methods such as, for example, piezo jet printing. Ink jet print heads or print engines that may be used for this task are easily adapted from commercially available ink jet printers. The resulting black or colored image typically has a resolution greater than about 100 dots per square inch (dpi), preferably greater than about 200 dpi, and more preferably in a range of about 300 dpi to about 1200 dpi, and most preferably in a range of about 300 dpi to about 800 dpi.

The edible image, e.g., high resolution printed image, formed on the edible color enhancement coating is comprised of at least one white, black or colored food grade ink. Such inks are typically comprised of one or more food grade dyes. Generally, the edible image will be comprised of a plurality of edible food grade inks that include cyan, magenta, yellow and black and white colored inks.

The ink jet printed image may be formed on a portion of the edible color enhancement coating or, if desired, may be formed on substantially all of the edible color enhancement coating.

The printed surface may be treated after printing to provide protection from abrasion and/or enhancement of the image quality. The treatment may include application of a glossy coat, a moisture barrier coat, a wax, or printing with other edible inks using screen printing or other printing technologies. Preferably, color images are applied by overlaying inks of different colors. More preferably, a protective coating substantially covering the edible color enhancement coating and the edible image is applied. The printed surface may be treated with protective coatings such as, for example, sugar compounds, glazes, gum arabic, dextin, carnauba wax, and the like.

It should be noted that the image to be printed, i.e., either a white image, black image or a colored image, using ink jet printing, can be derived from any analog or digital source, e.g., a computer hard drive, scanner, digital camera or over the internet. Systems for providing digital images to ink jet systems are described, for example, in co-pending U.S. patent application Ser. No. 09/587,108, filed Jun. 2, 2000, the entire disclosure of which is incorporated by reference herein. It is also possible to fade or vignetted the image at the edges thereof using available computer image-processing software, if desired. Such vignetted edges may also be achieved in the colored, white, or black image using pad printing techniques. It has been found to be most preferable to combine an edible ink jet printed image having a vignetted edge over an edible color enhancement coating having a vignetted edge where both the image and the substrate coating have substantially the same dimensions.

The present invention also includes a method for making a decorated edible product, comprising the steps of (a) providing an edible product having a non-chocolate edible surface; (b) applying a color enhancement coating to at least a portion of the non-chocolate edible surface; and (c) applying an edible image onto at least a portion of the color enhancement coating. Preferably, the image is a high resolution ink jet printed image.

In a particularly preferred embodiment, the method of printing described herein may be performed in a customizable process in which digital image information is selected by individual consumers and processed to form processed digital image information which is then used to print a high resolution color, black, or white image on the edible color enhancement coating. Such customizable processing, including the use of the Internet in such processing, is more fully described in co-pending U.S. patent application Ser. No. 09/587,108. It should be apparent that any of the image processing methods described therein would be applicable to the method of printing a colored, white, or black high resolution edible image on a non-chocolate edible surface as described herein.

An image input signal is provided to an image printing device, such as an ink jet printer. The input signal is either an analog or digital signal. Preferably, the image input signal is outputted from a device such as, for example, a digital camera, a camcorder, a computer, an internet source, an intranet source, an appliance, a telephony device, and the like.

In an alternative embodiment, the invention provides for a confectionary product having a non-chocolate edible surface that is at least partially covered with an edible color enhancement coating. The edible color enhancement coating is applied by ink jet printing and may be white, black, or any color. Though a substantially gray color is preferred.

In another embodiment of the invention the edible color enhancement coating has a vignetted edge, i.e., an edge area defining the perimeter of the coating is less dense than the inner area of the coating. More particularly, the dots per unit area at the perimeter edge of the substrate coating is gradually reduced as the edge of the substrate coating is approached from an interior direction until the coating ends. A vignetted edge area having a width of about 0.1 mm to about 2 mm may be generally employed, although wider and narrower vignetted edges may be used as desired. The use of an edible color enhancement coating having a vignetted edge advantageously reduces the sharp edge of the substrate coating. It may be preferable to round any sharp corners of the substrate coating to assist in reducing the perceived sharp edge of the substrate coating. The elimination of sharp edges also reduces the likelihood of damage to the substrate coating through abrasion.

It may also be preferable to round the corners of the inkjet printed image to reduce the sharpness of the edge of the image. In a preferred embodiment of the invention the ink jet printed image encompasses the entire area of a vignetted edible color enhancement coating. It has been found that printing the image to correspond to the perimeter of the vignetted edible color enhancement coating results in an edible ink jet printed image that provides an impression of particularly vibrant colors on the non-chocolate edible surface. In a particularly preferred embodiment, an edible inkjet printed image having a vignetted or faded edge is superimposed over an edible color enhancement coating having a vignetted edge.

To achieve the appearance of a vignetted edge, the background or image resolution is decreased. Typically, the resolution is less than about 300 dpi, and preferably a range of about 200 dpi to about 40 dpi, is used to create the vignetted edge.

For example, a vignetted edge may be achieved by applying the edible color enhancement coating by ink jet printing and instructing the printer via a computer to print fewer dots per unit area at the perimeter edge of the color enhancement coating being formed than at the non-perimeter edge area For example, the vignette tool of the “Adobe Photoshop” program available from Adobe, Inc., San Jose, Calif., may be used to ink jet print a vignetted edge. It is also possible to create a vignetted edge using pad printing.

Vignetting the edge may be used to enhance the image and appearance of a primary image. For example, a primary image that is surrounded by an edge may be partially or fully vignetted on all sides or at least one side. Typically, a primary image will be surrounded by four side edges. One or more of the side edges may be vignetted. Alternatively, the primary image may be surrounded by a soft edge, e.g., an oval or other rounded shape. Enhancement of the primary image can be achieved by vignetting at least a portion of the soft edge.

A variety of affects are created by using the vignetted edge appearance. For example, it can be used to create the appearance that the primary image flows into the background, or that the background fades into the primary image.

Other visual enhancements may be included to create the desired affect. For example, the primary image may be shown with a noticeable border surrounding the primary image. Advantageously, by leaving a noticeable border around the printed image, it may be possible to further enhance the visual perception of true color as described in co-pending patent application (Attorney Docket No. 02280.003560) titled, “Perimeter Enhancement On Edible Products,” filed contemporaneously.

The methods and inks of the invention are applicable to any edible product that can be decorated with an edible ink, including but not limited to, baked products, sugar-based products, pet foods, main meal and snack food products, pharmaceutical products, vegetables, fruits, produce, meat, poultry, eggs, dairy products, frozen foods, ice creams, and fried products. Naturally, this is particularly important where the inherent color of the edible product tends to distort the true color of the printed image.

The edible product may have many shapes and forms. It may be planar or nonplanar. For example, the edible product may be, substantially shaped like a box, square, cylinder, string, pie, sphere, triangle, rectangle, elliptical, lentil, or any other suitable form. In a preferred embodiment, the edible product is substantially lentil shaped. An example of a lentil shaped confectionery product is M&M's® Milk Chocolate Candies.

It is also desirable that the edible product be conveniently sized to be portable. In one embodiment, the edible product is a bite sized confectionery product. The term “bite sized” is used herein to denote products that resemble and/or are similar to normal sized products, but are sized so that the whole product or most of the product can be conveniently placed inside a consumer's mouth. Bite sized products often tend to be about 0.2 cm to about 3 cm in length. In another embodiment, the edible product is substantially lentil shaped with a diameter of about 1 cm to about 0.2 cm and has a thickness of about 0.3 cm to about 0.5 cm.

In a preferred embodiment, the edible product is comprised of a confectionery center that is coated with a sugar based coating, such as a sugar shell coating as applied by the known processes of hard panning or soft panning. The confectionery center may be, chocolate, taffy, peanut butter, nut, raisin, cookie, marshmallow, crispy extrudate, caramel, grain, malted crispy center, peanut creams, fondants, creams, nougat, brittles, and the like. In a particularly preferred embodiment, the confectionery product is bite sized and substantially lentil shaped and has a hard panned sugar shelled coating. The edible image may be printed on the sugar shelled coating, or a hydrophobic coating, e.g., wax coating, may be placed over the sugar shelled coating prior to printing.

The above-described techniques may be employed to obtain an edible product having a high resolution printed color, white, or black image on a dark or light colored surface. The edible product may or may not contain chocolate.

In one particularly preferred embodiment, the surface of a non-chocolate edible is at least partially coated with the edible color enhancement coating of the invention. An edible ink jet printed image is subsequently or almost simultaneously applied to the non-chocolate edible product, such that at least a portion of the ink jet printed image covers at least a portion of the edible color enhancement coating. The non-chocolate edible product may have a dark or light colored surface. Dark colors are exemplified by brown or black colors and their various shades. Light colors exemplify colors other than the dark colors discussed above.

### EXAMPLE 1

A yellow colored image is to be printed on a brown colored surface. To assist in bringing out the true color of the yellow colored image, a color enhancement coating is applied on the brown colored surface. The color enhancement coating is formulated to be a light gray color.

### EXAMPLE 2

A blue colored image is to be printed on a yellow colored surface. To assist in bringing out the true color of the blue colored image, a color enhancement coating is applied on the yellow colored surface. The color enhancement coating is formulated to be a medium-dark gray color.

### EXAMPLE 3

A blue colored image is to be printed on a yellow colored surface. To assist in bringing out the true color of the blue colored image, a color enhancement coating is applied on the yellow colored surface. The color enhancement coating is formulated to be a maroon/blue color.

### EXAMPLE 4

An orange colored image is to be printed on a yellow colored surface. To assist in bringing out the true color of the orange colored image, a color enhancement coating is applied on the yellow colored surface. The color enhancement coating is formulated to be a medium gray color.

### EXAMPLE 5

An orange colored image is to be printed on a yellow colored surface. To assist in bringing out the true color of the orange colored image, a color enhancement coating is applied on the yellow colored surface. The color enhancement coating is formulated to be a pale red color.

### EXAMPLE 6

A blue colored image is to be printed on a brown colored surface. To assist in bringing out the true color of the blue colored image, a color enhancement coating is applied on the brown colored surface. The color enhancement coating is formulated to be a white color.

### EXAMPLE 7

A yellow colored image is to be printed on a pale pink colored surface. To assist in bringing out the true color of the yellow colored image, a color enhancement coating is applied on the pale pink colored surface. The color enhancement coating is formulated to be a light gray color.

### EXAMPLE 8

A yellow colored image is to be printed on a pale pink colored surface. To assist in bringing out the true color of the yellow colored image, a color enhancement coating is applied on the pale pink colored surface. The color enhancement coating is formulated to be a color of yellow mixed equally with light gray.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

1. A decorated edible product comprising:
a non-chocolate edible surface,
an edible color enhancement coating disposed on at least a portion of said non-chocolate edible surface, and
an edible image formed on at least a portion of said color enhancement coating,
wherein said color enhancement coating enhances the colors of said edible image.

2. The product of claim 1, wherein said image is entirely formed on said color enhancement coating.

3. The product of claim 1, wherein said image is formed by the deposition of at least one of an edible white, black or color ink.

4. The product of claim 1, further comprising a protective coating substantially covering said edible color enhancement coating and said image.

5. The product of claim 1, wherein said non-chocolate edible surface is carbohydrate based, hydrophobic based, proteinaceous based, or pharmaceutically based.

6. The product of claim 1, wherein said non-chocolate edible surface is a hydrophobic based material selected from the group consisting of carnauba wax, candelilla wax, beeswax, fats, and mixtures thereof.

7. The product of claim 1, wherein said edible product contains chocolate.

8. The product of claim 1, wherein said edible product has a non-planar surface.

9. (canceled)

10. The product of claim 1, wherein said non-chocolate edible surface is a wax coating surrounding a sugar shelled coating.

11. The product of claim 1, wherein said edible color enhancement coating is applied using ink jet printing, flatbed screen printing, rotary screen printing, pad printing, etching, laser printing, offset rotogravure, flexographic, or gravure printing processes.

12. (canceled)

13. The product of claim 1, wherein said edible color enhancement coating has a thickness of about 1.8 mm to about 0.05 mm.

14. The product of claim 1, wherein said edible image has a resolution greater than about 100 dpi.

15. The product of claim 1, wherein
(a) said edible image is a light color, said non-chocolate edible surface is a dark color, and said color enhancement coating is a light gray color, or
(b) said edible image is a dark color, said non-chocolate edible surface is a light color, and said color enhancement coating is a dark gray color, or
(c) said edible image is a medium color, said non-chocolate edible surface is a light color, and said color enhancement coating is a medium gray color, or
(d) said edible image is a dark color, said non-chocolate edible surface is a dark color, and said color enhancement coating is a light gray color, or
(e) said edible image is a light color, said non-chocolate edible surface is a light color, and said color enhancement coating is a light gray color.

16. (canceled)

17. (canceled)

18. (canceled)

19. (canceled)

20. A method of making a decorated edible product having an edible image applied to a surface thereof, comprising the steps of:
(a) providing an edible product having a non-chocolate edible surface;
(b) applying an edible color enhancement coating to at least a portion of said non-chocolate edible surface of said edible product; and
(c) applying an edible image onto at least a portion of said color enhancement coating,
wherein said color enhancement coating enhances the colors of said edible image.

21. The method of claim 20, wherein said edible color enhancement coating is applied by ink jet printing, flatbed screen printing, rotary screen printing, pad printing, etching, laser printing, offset rotogravure, flexographic, or gravure printing processes.

22. (canceled)

23. (canceled)

24. The method of claim 20, wherein said image is derived from an edible ink jet printed image input signal.

25. The method of claim 24, wherein said image input signal is outputted from a device selected from the group consisting of a digital camera, a camcorder, a computer, an internet source, an intranet source, an appliance, or a telephony device.

26. The method of claim 20, wherein
(a) said edible image is a light color, said non-chocolate edible surface is a dark color, and said color enhancement coating is a light gray color, or
(b) said edible image is a dark color, said non-chocolate edible surface is a light color, and said color enhancement coating is a dark gray color, or
(c) said edible image is a medium color, said non-chocolate edible surface is a light color, and said color enhancement coating is a medium gray color, or
(d) said edible image is a dark color, said non-chocolate edible surface is a dark color, and said color enhancement coating is a light gray color, or
(e) said edible image is a light color, said non-chocolate edible surface is a light color, and said color enhancement coating is a light gray color.

27. A decorated non-chocolate edible product comprising:
a light colored non-chocolate edible surface,
an edible color enhancement coating that is substantially gray colored disposed on at least a portion of said non-chocolate edible surface, and
an edible image formed on at least a portion of said color enhancement coating,
wherein said color enhancement coating enhances the colors of said edible image.

28. The product of claim 27, wherein said non-chocolate edible surface is a hydrophobic based material selected from the group consisting of carnauba wax, candelilla wax, beeswax, fats, and mixtures thereof.
